(19) United States
(12) Patent Application Publication
(10) Pub. No.: US 2024/0097540 A1
(43) Pub. Date: Mar. 21, 2024

(54) HEATING DEVICE FOR LAMINATED IRON CORE

(71) Applicant: TANAKA ENGINEERING CO., LTD., Toyama (JP)

(72) Inventors: Eiichi KUROSAKI, Toyama (JP); Yuuma ITOU, Toyama (JP); Syuichi UEDA, Toyama (JP); Norio KAWAMI, Toyama (JP)

(21) Appl. No.: 18/038,509

(22) PCT Filed: Nov. 9, 2021
(86) PCT No.: PCT/JP2021/041103

§ 371 Date: May 24, 2023

(30) Foreign Application Priority Data
Dec. 9, 2020 (JP) 2020-203835
Aug. 27, 2021 (JP) 2021-138452

(51) Int. Cl. H02K 15/12; H02K 15/02

(52) U.S. Cl. CPC H02K 15/12; H02K 15/02; H02K 2215/00

(57) ABSTRACT

A heating device 10 for laminated iron core has a laminated iron core 18 as an object to be processed, and performs a heat treatment on an adhesive agent applied to the iron core 18. The device 10 includes a center guide 24, and the center guide 24 is an outer diameter variable chuck mechanism of which an outer diameter is variable.

### TECHNICAL FIELD

The present invention relates to a heating device for laminated iron core.

### BACKGROUND ART

A laminated iron core is used in motors and the like. The laminated iron core is obtained by bonding together iron cores. The bonding is achieved by performing a heat treatment on an adhesive agent. Various types of heating devices have been known for this purpose (refer to, for example, Patent Document 1 (FIG. 3)).

Patent Document 1 will be described with reference to the following drawings.

FIG. 8 is a view for describing a basic configuration of a heating device of the related art.

As illustrated in FIG. 8, a heating device 100 includes a base 101; a center guide 102 extending upward from the base 101; a base plate 103 and a lower plate 104 placed on the base 101 to surround the center guide 102; an induction heating coil 105 disposed to surround the base plate 103, the lower plate 104, and the center guide 102; and a top plate 107 and an upper plate 108 suspended by a cylinder 106.

A predetermined number of iron cores 109 are placed on the lower plate 104. At this time, the center guide 102 serves to guide the iron cores 109. In addition, the center guide 102 serves to prevent the iron cores 109 from moving in an axis-perpendicular direction (left-right direction in the drawing) of the center guide 102.

The cylinder 106 is extended to lower the top plate 107 and the upper plate 108, and to press the iron cores 109 via the upper plate 108.

In this state, the induction heating coil 105 is energized. A magnetic flux is generated from the induction heating coil 105. The magnetic flux generates an eddy current inside the iron cores 109. The eddy current generates Joule heat due to electrical resistance of the iron cores 109. When the adhesive agent is a thermoplastic resin, the adhesive agent is fluidized by heating and is cured thereafter. When the energization is stopped, the iron cores 109 are naturally cooled. Thereafter, the iron cores 109 are removed from the center guide 102.

FIG. 9 is an enlarged cross-sectional view of main parts of FIG. 8, and is a view illustrating a relationship between the center guide and the iron cores in the related art.

As illustrated in FIG. 9, the iron cores 109 are generally manufactured by punching a thin electromagnetic steel sheet (silicon steel sheet). For this reason, the hole diameter of center holes 111 unavoidably varies. In consideration of the variation and workability, a gap S is set between the center guide 102 and the iron cores 109. The gap δ is approximately 10 μm.

By the way, in FIG. 8, when setting the iron cores 109→heating→cooling→removing the iron cores 109 is defined as one production cycle, the production cycle is repeated.

The center guide 102 is also repeatedly heated and cooled, but the next heating may start before the temperature is sufficiently lowered. Namely, when the production cycle is repeated 10 times or more, the expansion of the center guide 102 accumulates, and it becomes difficult to set and remove the iron cores 109.

As a countermeasure, the gap δ is increased to approximately 30 μm. Even when the expansion of the center guide 102 accumulates, the iron cores 109 can be set or removed. However, when the gap δ is increased, some of the iron cores 109 become offset laterally when the adhesive agent is fluidized, and the finishing accuracy of the laminated iron core decreases.

As another countermeasure, the cooling time during one production cycle is extended, or cooling is performed for a sufficiently long period of time after the production cycle is repeated 10 times. The accumulation of expansion is eliminated by the countermeasure. However, the longer the cooling time becomes, the more the productivity decreases.

It is not preferable that the finishing accuracy of the laminated iron core decreases or the productivity decreases.

Therefore, a heating device in which a countermeasure against thermal expansion is taken for the center guide 102 is strongly desired.

### CITATION LIST

### Patent Document

Patent Document 1: Japanese Unexamined Patent Publication No. H7-298567

### DISCLOSURE OF THE INVENTION

### Problem to be Solved by the Invention

An object of the invention is to provide a heating device for laminated iron core in which a countermeasure against thermal expansion is taken for a center guide.

### Means for Solving Problem

According to a first aspect of the invention, there is provided a heating device for laminated iron core that takes a laminated iron core as an object to be processed, and that performs a heat treatment on an adhesive agent applied to the iron core, the device including: a base plate; a lower plate placed on the base plate; an upper plate placed on the iron core placed on the lower plate; a top plate placed on the upper plate, the base plate and the top plate being made of stainless steel not allowing a magnetic flux to easily pass through, and the lower plate and the upper plate being made of carbon steel passing the magnetic flux; an induction heating coil surrounding the iron core; a tubular ferrite surrounding the induction heating coil; a lower ferrite extending from a lower end of the tubular ferrite to the lower plate; an upper ferrite extending from an upper end of the tubular ferrite to the upper plate; and a center guide inserted into a center hole provided in the iron core. The center guide is an outer diameter variable chuck mechanism of which an outer diameter is variable. The outer diameter variable chuck mechanism includes an air cylinder, a slider moved by the air cylinder, a rail that guides the slider, and a movable claw attached to the slider. The air cylinder, the slider, and the rail are disposed outside a region sandwiched between the base plate and the top plate.

According to a second aspect of the invention, there is provided a heating device for laminated iron core that takes a laminated iron core as an object to be processed, and that performs a heat treatment on an adhesive agent applied to the iron core, the device including: a base plate; a lower plate placed on the base plate; an upper plate placed on the iron core placed on the lower plate; a top plate placed on the upper plate, the base plate and the top plate being made of stainless steel not allowing a magnetic flux to easily pass through, and the lower plate and the upper plate being made of carbon steel passing the magnetic flux; an induction heating coil surrounding the iron core; and a center guide inserted into a center hole provided in the iron core. The center guide is an outer diameter variable chuck mechanism of which an outer diameter is variable. The outer diameter variable chuck mechanism includes an air cylinder, a slider moved by the air cylinder, a rail that guides the slider, and a movable claw attached to the slider. The air cylinder, the slider, and the rail are disposed outside a region sandwiched between the base plate and the top plate.

According to a third aspect of the invention, there is provided a heating device for laminated iron core that takes a laminated iron core as an object to be processed, and that performs a heat treatment on an adhesive agent applied to the iron core, the device including: a base plate; a lower plate placed on the base plate; an upper plate placed on the iron core placed on the lower plate; a top plate placed on the upper plate, the base plate and the top plate being made of stainless steel not allowing a magnetic flux to easily pass through, and the lower plate and the upper plate being made of carbon steel passing the magnetic flux; an induction heating coil surrounding the iron core; and a center guide inserted into a center hole provided in the iron core. The center guide is an outer diameter variable chuck mechanism of which an outer diameter is variable. The outer diameter variable chuck mechanism includes a rail, a slider guided by the rail, and a movable claw attached to the slider. The slider and the rail are disposed outside a region sandwiched between the base plate and the top plate.

According to a fourth aspect of the invention, preferably, in the heating device for laminated iron core according to any one of the first to third aspects, the outer diameter variable chuck mechanism includes three claws disposed at a pitch of 120° in a plan view, and two of the claws are fixed claws and a remaining one is the movable claw.

According to a fifth aspect of the invention, preferably, in the heating device for laminated iron core according to the fourth aspect, the fixed claws and the movable claw are inserted into the center hole of the iron core heated by the induction heating coil, and at least one of the fixed claws and the movable claw includes a refrigerant passage for cooling so as to suppress a change in a temperature of the at least one of the fixed claws and the movable claw.

According to a sixth aspect of the invention, preferably, in the heating device for laminated iron core according to any one of the first to third aspects, the outer diameter variable chuck mechanism includes two claws disposed at a pitch of 180° in a plan view, and one of the claws is a fixed claw and a remaining one is the movable claw.

According to a seventh aspect of the invention, preferably, in the heating device for laminated iron core according to the sixth aspect, the fixed claw and the movable claw are inserted into the center hole of the iron core heated by the induction heating coil, and at least one of the fixed claw and the movable claw includes a refrigerant passage for cooling so as to suppress a change in a temperature of the at least one of the fixed claw and the movable claw.

### Effect of the Invention

According to the first aspect of the invention, the outer diameter of the center guide is variable. The outer diameter is reduced, and the iron core is set in the center guide. Even when the temperature of the center guide rises, the setting of the iron core is not affected.

After setting, the outer diameter of the center guide is aligned with the hole diameter of the center hole of the iron core. During the heat treatment, the iron core does not move.

When the iron core is removed from the center guide, the outer diameter is also reduced. Even when the temperature of the center guide rises, the removal of the iron core is not affected.

Therefore, according to the invention, there is provided the heating device for laminated iron core in which a countermeasure against thermal expansion is taken for the center guide.

In addition, according to the first aspect of the invention, the induction heating coil surrounding the iron core is surrounded by the tubular ferrite. The utilization of some of the magnetic flux generated by the induction heating coil is promoted by the tubular ferrite.

However, the magnetic flux extending from the tubular ferrite is partially blocked by the base plate or the top plate. The blocking includes not allowing the magnetic flux to easily pass through. The same applies to the following.

As a countermeasure, in the invention, the lower ferrite and the upper ferrite are attached to the tubular ferrite.

The magnetic flux extending from the tubular ferrite is induced by the lower ferrite and the upper ferrite, and is provided to heat the iron core.

In the invention, the iron core is heated to a predetermined temperature in a shorter period of time. On the other hand, since the heating efficiency is good, the temperature rise of the center guide is high, and thermal expansion increases. However, in a case where the center guide is the outer diameter variable chuck mechanism, thermal expansion does not become a problem.

Therefore, according to the invention, there is provided the heating device for laminated iron core in which a countermeasure against thermal expansion is taken for the center guide while increasing the heating efficiency of the iron core.

Furthermore, according to the first aspect of the invention, the outer diameter variable chuck mechanism includes the air cylinder, the slider moved by the air cylinder, the rail that guides the slider, and the movable claw attached to the slider. The air cylinder, the slider, and the rail are disposed outside the region sandwiched between the base plate and the top plate.

According to the second aspect of the invention, similarly to the first aspect, the outer diameter of the center guide is variable. The outer diameter is reduced, and the iron core is set in the center guide. Even when the temperature of the center guide rises, the setting of the iron core is not affected.

After setting, the outer diameter of the center guide is aligned with the hole diameter of the center hole of the iron core. During the heat treatment, the iron core does not move.

When the iron core is removed from the center guide, the outer diameter is also reduced. Even when the temperature of the center guide rises, the removal of the iron core is not affected.

Therefore, according to the invention, there is provided the heating device for laminated iron core in which a countermeasure against thermal expansion is taken for the center guide.

In the invention, the iron core is heated to the predetermined temperature in a shorter period of time. On the other hand, since the heating efficiency is good, the temperature rise of the center guide is high, and thermal expansion increases. However, in a case where the center guide is the outer diameter variable chuck mechanism, thermal expansion does not become a problem.

Therefore, according to the invention, there is provided the heating device for laminated iron core in which a countermeasure against thermal expansion is taken for the center guide while increasing the heating efficiency of the iron core.

Furthermore, according to the second aspect of the invention, the outer diameter variable chuck mechanism includes the air cylinder, the slider moved by the air cylinder, the rail that guides the slider, and the movable claw attached to the slider. The air cylinder, the slider, and the rail are disposed outside the region sandwiched between the base plate and the top plate.

According to the third aspect of the invention, similarly to the first aspect, the outer diameter of the center guide is variable. The outer diameter is reduced, and the iron core is set in the center guide. Even when the temperature of the center guide rises, the setting of the iron core is not affected.

After setting, the outer diameter of the center guide is aligned with the hole diameter of the center hole of the iron core. During the heat treatment, the iron core does not move.

When the iron core is removed from the center guide, the outer diameter is also reduced. Even when the temperature of the center guide rises, the removal of the iron core is not affected.

Therefore, according to the invention, there is provided the heating device for laminated iron core in which a countermeasure against thermal expansion is taken for the center guide.

In the invention, the iron core is heated to the predetermined temperature in a shorter period of time. On the other hand, since the heating efficiency is good, the temperature rise of the center guide is high, and thermal expansion increases. However, in a case where the center guide is the outer diameter variable chuck mechanism, thermal expansion does not become a problem.

Therefore, according to the invention, there is provided the heating device for laminated iron core in which a countermeasure against thermal expansion is taken for the center guide while increasing the heating efficiency of the iron core.

Furthermore, according to the third aspect of the invention, the outer diameter variable chuck mechanism includes the rail, the slider guided by the rail, and the movable claw attached to the slider. The slider and the rail are disposed outside the region sandwiched between the base plate and the top plate.

According to the fourth aspect of the invention, main parts of the outer diameter variable chuck mechanism are composed of two fixed claws and one movable claw. Compared to a structure in which all the three claws are variable claws, when only one is a movable claw, the device can be simplified, so that the equipment cost can be reduced.

According to the fifth aspect of the invention, the claws are provided with refrigerant passages. The temperature rise of the claws can be suppressed by cooling the claws with water or the like. Compared to a structure in which the claws are naturally cooled by the atmosphere, when forced cooling is performed using a refrigerant, the time required to cool the claws can be shortened, and the operating rate of the heating device can be increased.

According to the sixth aspect of the invention, main parts of the outer diameter variable chuck mechanism are composed of one fixed claw and one movable claw. Compared to a structure in which two fixed claws are provided, when one fixed claw is provided, the device can be further simplified, so that the equipment cost can be further reduced.

According to the seventh aspect of the invention, the claws are provided with refrigerant passages. The temperature rise of the claws can be suppressed by cooling the claws with water or the like. Compared to a structure in which the claws are naturally cooled by the atmosphere, when forced cooling is performed using the refrigerant, the time required to cool the claws can be shortened, and the operating rate of the heating device can be increased.

### BRIEF DESCRIPTION OF DRAWINGS

FIG. 1 is a cross-sectional view of a heating device for laminated iron core according to the invention;

FIG. 2 is a view for describing a magnetic flux, FIG. 2(a) illustrates a comparative example, and FIG. 2(b) illustrates an embodiment;

FIG. 3 is a cross-sectional view taken along line 3-3 of FIG. 1:

FIG. 4 is a cross-sectional view taken along line 4-4 of FIG. 1;

FIGS. 5(a) to 5(d) are views for describing the operation of an outer diameter variable chuck mechanism;

FIGS. 6(a) to 6(c) are views for describing a modification example of the outer diameter variable chuck mechanism:

FIG. 7 is a view for describing a refrigerant passage;

FIG. 8 is a view for describing a basic configuration of a heating device of the related art; and

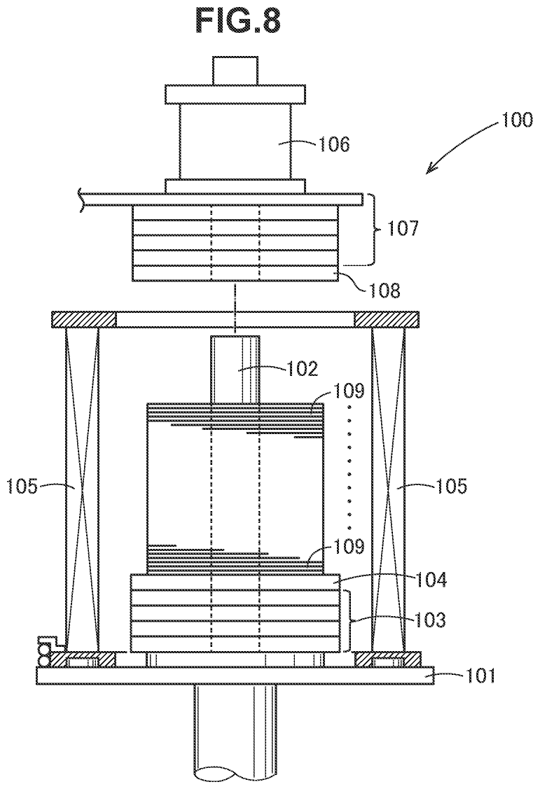

FIG. 9 is an enlarged cross-sectional view of main parts of FIG. 8, and is a view illustrating a relationship between a center guide and iron cores in the related art.

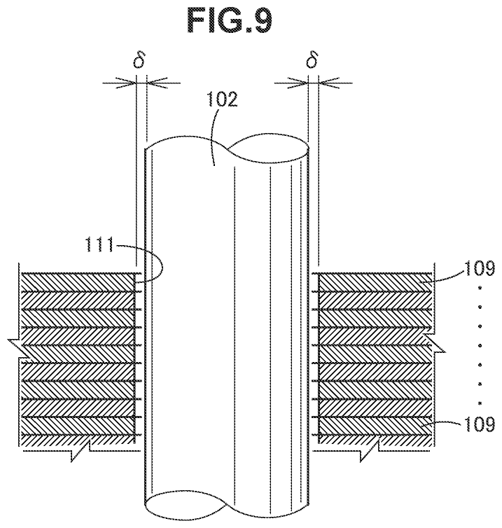

### MODE(S) FOR CARRYING OUT THE INVENTION

An embodiment of the invention will be described below with reference to the accompanying drawings.

### Embodiment

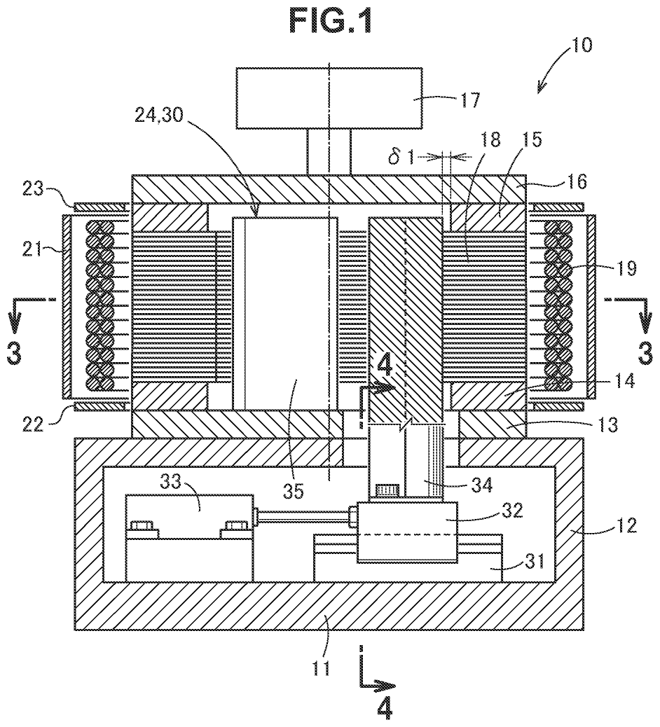

As illustrated in FIG. 1, a heating device 10 for laminated iron core includes a stand base 11; a gantry base 12 placed on the stand base 11; a base plate 13 placed on the gantry base 12; a lower plate 14 placed on the base plate 13; an upper plate 15 disposed above the lower plate 14; a top plate 16 placed on the upper plate 15; a pressing mechanism 17 that applies a downward force to the top plate 16; an induction heating coil 19 disposed to surround iron cores 18; a tubular ferrite 21 disposed to surround a side surface of the induction heating coil 19; a lower ferrite 22 disposed from a lower end of the tubular ferrite 21 to the lower plate 14; an upper ferrite 23 disposed to extend from an upper end of the tubular ferrite 21 to the upper plate 15; and a center guide 24 that is sandwiched between the lower plate 14 and the upper plate 15 and that positions the iron cores 18.

Incidentally, the fact that the lower ferrite 22 extends from the lower end of the tubular ferrite 21 refers to both a structure where the lower ferrite 22 is disposed at a predetermined distance from the lower end of the tubular ferrite 21 and a structure where the lower ferrite 22 is disposed in contact with the lower end of the tubular ferrite 21. The same applies to the upper ferrite 23.

The center guide 24 is an outer diameter variable chuck mechanism 30.

The outer diameter variable chuck mechanism 30 includes, for example, a rail 31 placed on the stand base 11; a slider 32 movably fitted to the rail 31; an air cylinder 33 that drives the slider 32; a movable claw 34 having a columnar shape and extending upward from the slider 32 to penetrate through the gantry base 12, the base plate 13, the lower plate 14, the iron cores 18, and the upper plate 15; and a fixed claw 35 having a columnar shape, disposed in parallel to the movable claw 34, and extending upward from the base plate 13 to penetrate through the lower plate 14, the iron cores 18, and the upper plate 15.

Each of the iron cores 18 is a silicon steel sheet (electromagnetic steel sheet) with a thickness of 0.2 to 0.5 mm, and is a perforated sheet with an inner diameter of 50 to 150 mm and an outer diameter of 200 to 250 mm.

A laminated iron core, for example, with a height of 50 to 150 mm is obtained by locally (or entirely) applying an adhesive agent with a thickness of several μm to upper and lower surfaces of the iron cores 18 formed by punching a silicon steel sheet coil using a press, and by piling (laminating) a predetermined number of the perforated sheets to which the adhesive agent is applied.

The adhesive agent may be a thermosetting resin that is fluidized by heating and is cured at approximately 180° C., such as epoxy-based resin, acrylic-based resin, or silicone rubber-based resin, and can be freely selected.

The lower plate 14 and the upper plate 15 are carbon steel sheets.

Preferably, a gap δ1 of approximately several mm is secured between the fixed claw 35 or the movable claw 34 and both the lower plate 14 and the upper plate 15. The gap δ1 blocks or suppresses the transfer of heat from the lower plate 14 and the upper plate 15 to the fixed claw 35 or the movable claw 34.

Next, the presence or absence of the lower ferrite 22 and the upper ferrite 23 and the material of the base plate 13 and the top plate 16 will be examined.
Case 1: when the base plate 13 and the top plate 16 are made of carbon steel, and the lower ferrite 22 and the upper ferrite 23 are not provided:
   A magnetic flux generated by the induction heating coil 19 passes through the tubular ferrite 21, the lower plate 14, the upper plate 15, the base plate 13, and the top plate 16.

The tubular ferrite 21 promotes the utilization of the magnetic flux.

The lower plate 14 and the upper plate 15 are heated by the magnetic flux, and transfer heat to the iron cores 18.

The base plate 13 and the top plate 16 are also heated by the magnetic flux. Some of the heat is directed toward the lower plate 14 and the upper plate 15, but much of the heat is radiated to the atmosphere. The heat radiation causes a decrease in the heating efficiency of the iron cores 18.
Case 2: when the base plate 13 and the top plate 16 are made of stainless steel, and the lower ferrite 22 and the upper ferrite 23 are not provided:
   Since the base plate 13 and the top plate 16 do not pass the magnetic flux generated by the induction heating coil 19, the magnetic flux passes through the tubular ferrite 21, the lower plate 14, and the upper plate 15.

The tubular ferrite 21 promotes the utilization of the magnetic flux.

The lower plate 14 and the upper plate 15 are heated by the magnetic flux, and transfer heat to the iron cores 18.

Since heat radiation from the base plate 13 and the top plate 16 to the atmosphere is eliminated or suppressed, the case 2 is preferable to the case 1.

Therefore, the base plate 13 and the top plate 16 are made of stainless steel that does not allow the magnetic flux to easily pass through.

There are austenite-based, ferrite-based, and martensite-based stainless steels. The ferrite-based and martensite-based stainless steels are magnetic materials, and are not suitable since the ferrite-based and martensite-based stainless steels pass the magnetic flux well.

On the other hand, the austenite-based stainless steel (for example, SUS304) is a non-magnetic material, and is suitable since the austenite-based stainless steel does not allow the magnetic flux to easily pass through.

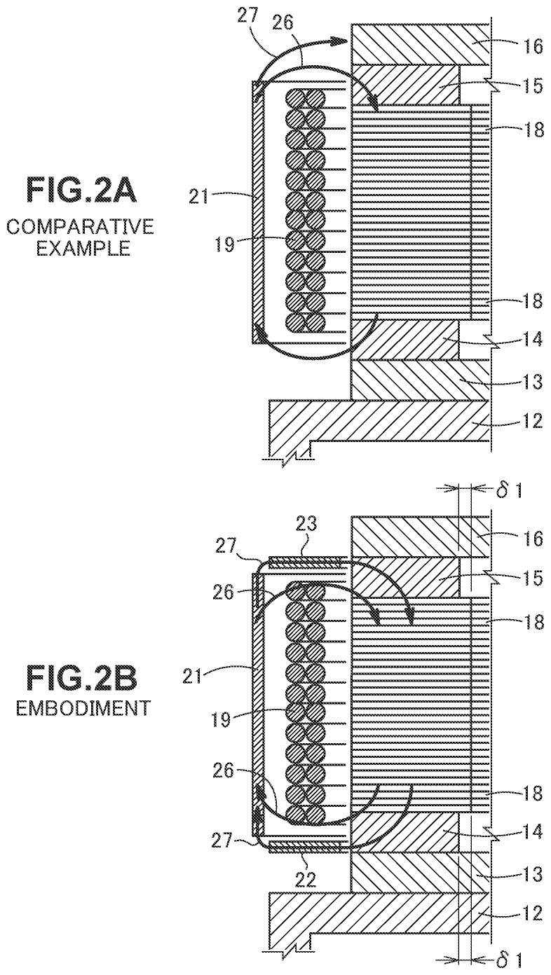

The structure of the case 2 described above will be further described with reference to FIG. 2(a), and a structure improved from the case 2 will be described with reference to FIG. 2(b). In addition, actions of the tubular ferrite 21, the lower ferrite 22, and the upper ferrite 23 will be described with reference to FIG. 2(a) and FIG. 2(b).

FIG. 2(a) illustrates a comparative example. As illustrated in FIG. 2(a), the tubular ferrite 21 serves to promoting an effective use of a magnetic flux generated by the induction heating coil 19.

Some of a magnetic flux 26 passes through the iron cores 18 via the upper plate 15 or the lower plate 14. In addition, another magnetic flux 27 is directed toward the base plate 13 or the top plate 16. The base plate 13 or the top plate 16 blocks the magnetic flux 27. For this reason, the magnetic flux 27 is not effectively utilized.

FIG. 2(b) illustrates the embodiment. As illustrated in FIG. 2(b), the magnetic flux 27 is induced by the lower ferrite 22 and the upper ferrite 23. Since the upper plate 15 and the lower plate 14 are carbon steel sheets, the upper plate 15 and the lower plate 14 pass the magnetic flux 27.

Namely, the magnetic flux 27 passes through the upper plate 15, passes through the iron cores 18, passes through the lower plate 14, and returns to the tubular ferrite 21. As a result, the magnetic flux 27 is effectively utilized.

Therefore, attaching the lower ferrite 22 and the upper ferrite 23 to the tubular ferrite 21 is effective.

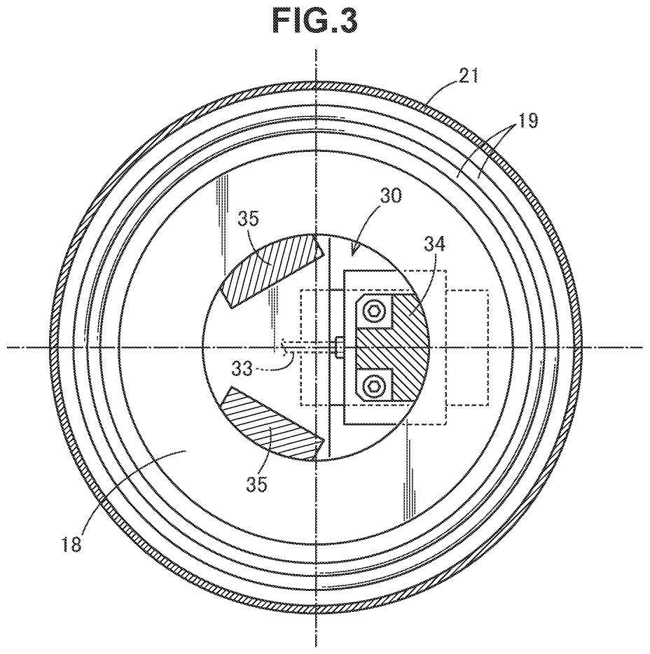

As illustrated in FIG. 3, the outer diameter variable chuck mechanism 30 includes three claws 34, 35, and 35 disposed at a pitch of 120° in a plan view, and two of the claws are the fixed claws 35 and 35, and the remaining one is the movable claw 34 driven by the air cylinder 33.

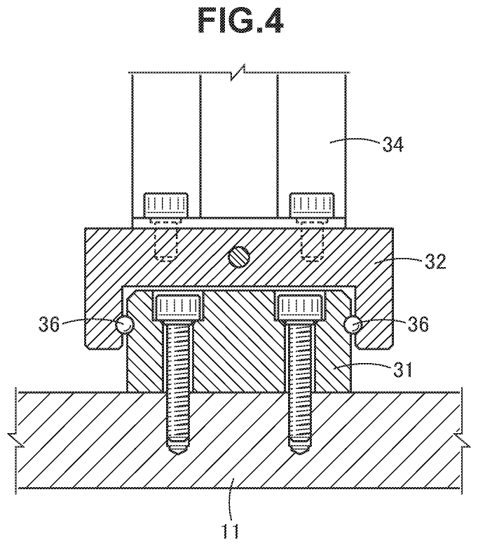

As illustrated in FIG. 4, the rail 31 is placed on the stand base 11, the slider 32 is fitted to the rail 31 so as to be movable in a front-back direction of the drawings, and the movable claw 34 is fixed to the slider 32 by bolts or the like. Preferably, steel balls 36 are interposed between the rail 31 and the slider 32. When the steel balls 36 are interposed, the coefficient of friction between the rail 31 and the slider 32 is greatly reduced, and the slider 32 and the movable claw 34 move smoothly without shaking.

Incidentally, one rail 31 may be replaced with a left guide bar and a right guide bar, and the slider 32 may be guided by the left guide bar and the right guide bar. Therefore, the structure of FIG. 4 may be modified as appropriate without any issue, and the movable claw 34 may be basically structured to move smoothly without shaking or wobbling.

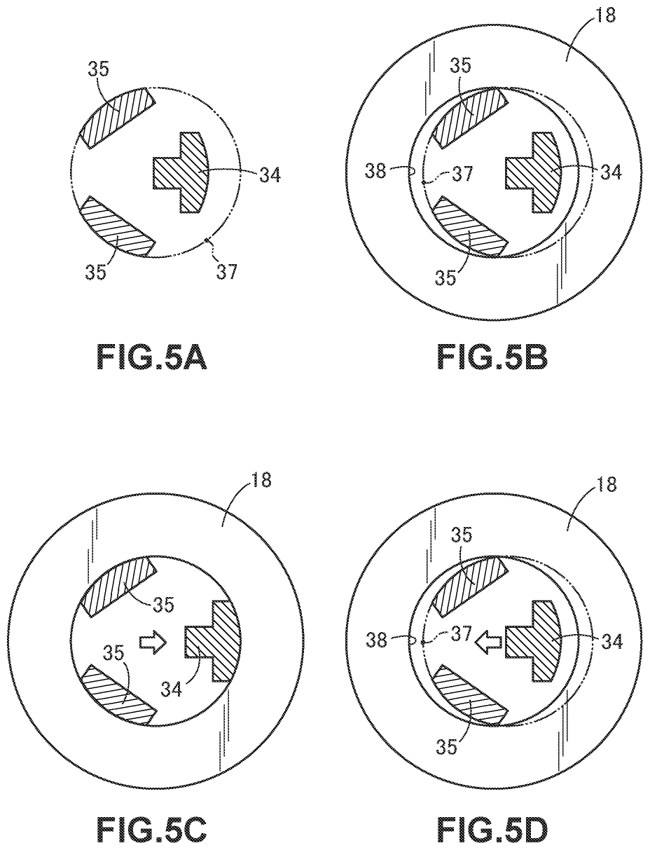

An action of the outer diameter variable chuck mechanism 30 with the above-described configuration will be described with reference to FIG. 5.

Before the iron cores are set, as illustrated in FIG. 5(a), the movable claw 34 is retracted from a circumscribed circle 37 of the fixed claws 35.

As illustrated in FIG. 5(b), the iron cores 18 are set. At this time, center holes 38 of the iron cores 18 are set to be offset from the circumscribed circle 37. The center holes 38 can be set not to come into contact with the three claws 34, 35, and 35.

As illustrated in FIG. 5(c), the movable claw 34 is advanced. An advancing force of the air cylinder (reference numeral 33 FIG. 1) is always applied to the movable claw 34. As a result, the two fixed claws 35 and the one movable claw 34 come into close contact with the iron cores 18. In this state, heating is performed, and the adhesive agent is fluidized and cured.

In the heating process, the iron cores 18 are not offset in the left-right direction of the drawing. The laminated iron core with good dimensional accuracy is obtained.

After the heating is completed, as illustrated in FIG. 5(d), the movable claw 34 is retracted. The movable claw 34 is separated from the iron cores 18, and the iron cores 18 are separated from the fixed claws 35. As a result, the iron cores 18 can be easily removed, and work efficiency is increased.

Next, a modification example according to the invention will be described.

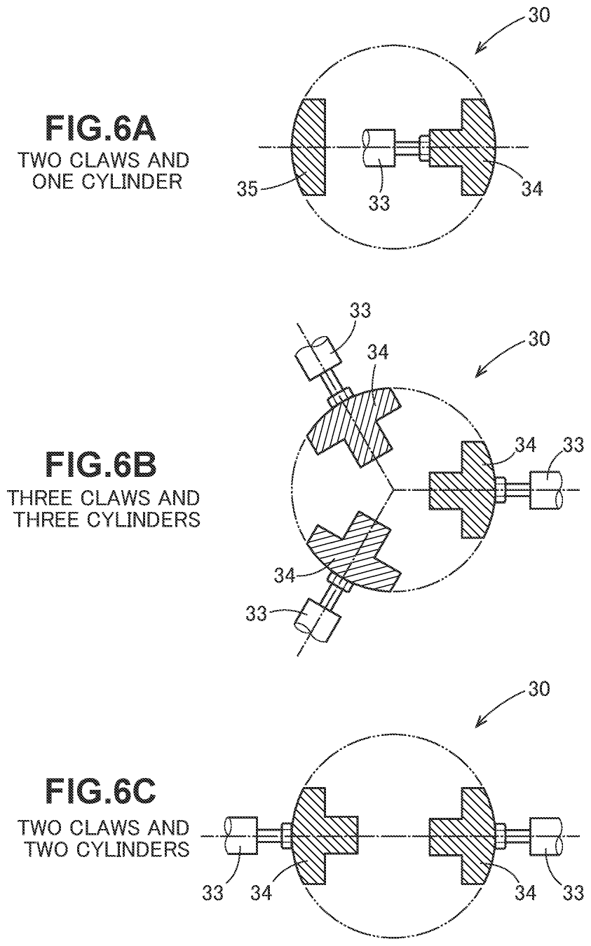

As illustrated in FIG. 6(a), the outer diameter variable chuck mechanism 30 may include two claws 34 and 35 disposed at a pitch of 180° in a plan view, and one of the claws may be the fixed claw 35 and the remaining one may be the movable claw 34 driven by the air cylinder 33.

Since the number of the fixed claws 35 is one, the outer diameter variable chuck mechanism 30 is simplified.

In addition, as illustrated in FIG. 6(b), the outer diameter variable chuck mechanism 30 may include three movable claws 34 disposed at a pitch of 120° in a plan view, and each of the movable claws 34 may be driven by the air cylinder 33.

In addition, as illustrated in FIG. 6(c), the outer diameter variable chuck mechanism 30 may include two movable claws 34 disposed at a pitch of 180° in a plan view, and each of the movable claws 34 may be driven by the air cylinder 33.

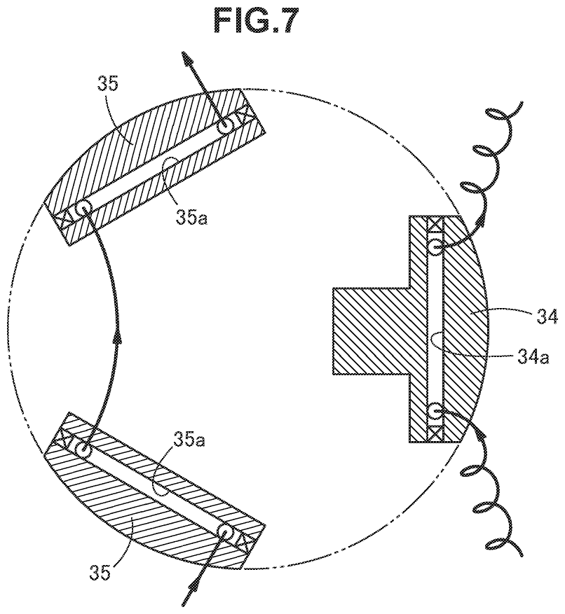

In addition, as illustrated in FIG. 7, the fixed claws 35 may be provided with refrigerant passages 35a for cooling, and the movable claw 34 may be provided with a refrigerant passage 34a for cooling. The refrigerant passages 34a and 35a can suppress a change in the temperature of the fixed claws 35 or the movable claw 34 by passing water or air.

The refrigerant passages 34a and 35a are not indispensable; however, in the heating device 10 for laminated iron core illustrated in FIG. 1, when the production cycle is continuously performed 10 times, the temperature of the fixed claws 35 or the movable claw 34 gradually rises.

As a countermeasure, for example, it can be considered that after 10 production cycles are completed, a “brief cooling time” is provided, and thereafter, the next 10 production cycles are restarted. However, when the countermeasure is taken, the productivity slightly decreases.

In the structure illustrated in FIG. 7, there is no need to provide the “brief cooling time”, and the productivity increases.

Incidentally, in FIG. 7, not only both the refrigerant passage 34a and the refrigerant passages 35a can be provided, but also only one can be provided. A flexible hose needs to be connected to the refrigerant passage 34a provided in the movable claw 34, and the equipment cost is increased. When only the refrigerant passages 35a are provided without providing the refrigerant passage 34a, the flexible hose is not required, and the equipment cost can be lowered.

### INDUSTRIAL APPLICABILITY

The invention is suitable to the heating device that heats the iron cores with the adhesive agent to obtain the laminated iron core.

### EXPLANATIONS OF LETTERS OR NUMERALS

10 HEATING DEVICE FOR LAMINATED IRON CORE
13 BASE PLATE
14 LOWER PLATE
15 UPPER PLATE
16 TOP PLATE
18 IRON CORE
19 INDUCTION HEATING COIL
21 TUBULAR FERRITE
22 LOWER FERRITE
23 UPPER FERRITE
24 CENTER GUIDE
26, 27 MAGNETIC FLUX
30 OUTER DIAMETER VARIABLE CHUCK MECHANISM
31 RAIL
32 SLIDER
33 AIR CYLINDER
34 MOVABLE CLAW
34a, 35a REFRIGERANT PASSAGE
35 FIXED CLAW
38 CENTER HOLE

1. A heating device for laminated iron core that takes a laminated iron core as an object to be processed, and that performs a heat treatment on an adhesive agent applied to the iron core, the device comprising:
a base plate;
a lower plate placed on the base plate;
an upper plate placed on the iron core placed on the lower plate;
a top plate placed on the upper plate, the base plate and the top plate being made of stainless steel not allowing a magnetic flux to easily pass through, and the lower plate and the upper plate being made of carbon steel passing the magnetic flux;
an induction heating coil surrounding the iron core;
a tubular ferrite surrounding the induction heating coil;
a lower ferrite extending from a lower end of the tubular ferrite to the lower plate;
an upper ferrite extending from an upper end of the tubular ferrite to the upper plate; and
a center guide inserted into a center hole provided in the iron core,
wherein the center guide is an outer diameter variable chuck mechanism of which an outer diameter is variable,
the outer diameter variable chuck mechanism includes an air cylinder, a slider moved by the air cylinder, a rail that guides the slider, and a movable claw attached to the slider, and
the air cylinder, the slider, and the rail are disposed outside a region sandwiched between the base plate and the top plate.

2. A heating device for laminated iron core that takes a laminated iron core as an object to be processed, and that performs a heat treatment on an adhesive agent applied to the iron core, the device comprising:
a base plate;
a lower plate placed on the base plate;
an upper plate placed on the iron core placed on the lower plate;
a top plate placed on the upper plate, the base plate and the top plate being made of stainless steel not allowing a magnetic flux to easily pass through, and the lower plate and the upper plate being made of carbon steel passing the magnetic flux;
an induction heating coil surrounding the iron core; and
a center guide inserted into a center hole provided in the iron core,
wherein the center guide is an outer diameter variable chuck mechanism of which an outer diameter is variable,
the outer diameter variable chuck mechanism includes an air cylinder, a slider moved by the air cylinder, a rail that guides the slider, and a movable claw attached to the slider, and
the air cylinder, the slider, and the rail are disposed outside a region sandwiched between the base plate and the top plate.

3. A heating device for laminated iron core that takes a laminated iron core as an object to be processed, and that performs a heat treatment on an adhesive agent applied to the iron core, the device comprising:
a base plate;
a lower plate placed on the base plate;
an upper plate placed on the iron core placed on the lower plate;
a top plate placed on the upper plate, the base plate and the top plate being made of stainless steel not allowing a magnetic flux to easily pass through, and the lower plate and the upper plate being made of carbon steel passing the magnetic flux;
an induction heating coil surrounding the iron core; and
a center guide inserted into a center hole provided in the iron core,
wherein the center guide is an outer diameter variable chuck mechanism of which an outer diameter is variable,
the outer diameter variable chuck mechanism includes a rail, a slider guided by the rail, and a movable claw attached to the slider, and
the slider and the rail are disposed outside a region sandwiched between the base plate and the top plate.

4. The heating device for laminated iron core according to claim 1,
wherein the outer diameter variable chuck mechanism includes three claws disposed at a pitch of 120° in a plan view, and
two of the claws are fixed claws and a remaining one is the movable claw.

5. The heating device for laminated iron core according to claim 4,
wherein the fixed claws and the movable claw are inserted into the center hole of the iron core heated by the induction heating coil, and
at least one of the fixed claws and the movable claw includes a refrigerant passage for cooling so as to suppress a change in a temperature of the at least one of the fixed claws and the movable claw.

6. The heating device for laminated iron core according to claim 1,
wherein the outer diameter variable chuck mechanism includes two claws disposed at a pitch of 180° in a plan view, and
one of the claws is a fixed claw and a remaining one is the movable claw.

7. The heating device for laminated iron core according to claim 6,
wherein the fixed claw and the movable claw are inserted into the center hole of the iron core heated by the induction heating coil, and
at least one of the fixed claw and the movable claw includes a refrigerant passage for cooling so as to suppress a change in a temperature of the at least one of the fixed claw and the movable claw.
